(19) United States
(12) Patent Application Publication
(10) Pub. No.: US 2022/0351127 A1
(43) Pub. Date: Nov. 3, 2022

(54) FLEXIBLE PIECE LEVEL TRACKING IN A FREIGHT CONTEXT

(71) Applicant: Unisys Corporation, Blue Bell, PA (US)

(72) Inventors: Andrea Baur, Eagan, MN (US); Prasenjit Barat, Karnataka (IN); Sandeep Saratchandra Kumar, Karnataka (IN); Anoop Kattungal Mohandas, Karnataka (IN)

(21) Appl. No.: 17/373,861

(22) Filed: Jul. 13, 2021

(30) Foreign Application Priority Data
Apr. 29, 2021 (IN) 202111019615

(51) Int. Cl. G06Q 10/08; G06N 5/02

(52) U.S. Cl. CPC G06Q 10/0833; G06Q 10/0838; G06N 5/025

(57) ABSTRACT

Methods and system for piece level tracking in a freight context. In one aspect, a freight tracking system includes a freight logistics computing device comprising a processor executing instructions stored in memory. The instructions cause the processer to receive an order for shipping goods in bulk at a goods level, wherein the order is associated with a plurality of pieces, define a rules engine which is configured to enable or disable piece level tracking, track at least one piece of the plurality of pieces at a piece level when piece level tracking is enabled, and expose a record providing piece level information including when the at least one piece contains different information from at least one other piece of the plurality of pieces.

### TECHNICAL FIELD

This invention relates to the field of freight tracking. More particularly, this invention relates to the integration of a flexible rules engine to allow for piece level tracking in a freight context.

### BACKGROUND

In the freight context, packages containing various items in an order are shipped either in bulk or prepacked in Shipper Loaded Unit Load Device (ULDs). These packages may be tracked from a specific source to a specific destination based on an air waybill. The air waybill frequently has many packages associated with a specific source and a specific destination. These packages may travel together or may be split at different points before arriving at the destination.

Currently, in the freight context split shipments are tracked, but individual packages within the split shipment are not tracked. For example, information about how many packages are within each split shipment and the location of the split shipment are known, but the specific location of a specific package is not tracked. Therefore, customers who are interested in finding the specific location and status of one particular package within such a split shipment are not able to do so.

Tracking the information, such as weight, volume, contents of individual packages, special handling codes, status and location is difficult in the freight context because it is labor intensive to input data for each package which may be shipped in a freight context. Therefore, requiring each package to be entered on an air waybill in all cases is not a desirable solution.

### SUMMARY

In general terms, this disclosure is directed to the tracking of goods in a freight context. This disclosure relates generally to piece level tracking of goods which are shipped in bulk and not in prebuild Shipper Loaded ULDs.

In a first aspect, a freight tracking system includes a freight logistics computing device comprising a processor executing instructions stored in memory. Where the instructions cause the processor to receive an order for shipping goods in bulk at a goods level, wherein the order is associated with a plurality of pieces. The instructions further cause the processor to define a rules engine which is configured to enable or disable piece level tracking, track at least one piece of the plurality of pieces at a piece level when piece level tracking is enabled, and expose a record providing piece level information including when the at least one piece contains different information from at least one other piece of the plurality of pieces.

In another embodiment, a freight tracking method is disclosed. The method includes receiving an order for shipping goods in bulk at a goods level. Where the order is associated with a plurality of pieces. The method also includes defining a rules engine which is configured to enable or disable piece level tracking, tracking at least one piece of the plurality of pieces at a piece level when piece level tracking is enabled, and exposing a record providing piece level information including when the at least one piece contains different information from at least one other piece of the plurality of pieces.

In another embodiment, another freight tracking method is disclosed. The method includes placing an order for shipping goods in bulk at a goods level where the order is associated with a plurality of pieces. The method also includes selecting at least one piece of the plurality of pieces for piece level tracking. Where selecting at least one piece for piece level tracking checks a rules engine to enable piece level tracking. In addition to the above the method includes providing piece level information for the at least one piece and receiving a record providing piece level information including a unique piece identifier for the at least one piece.

### BRIEF DESCRIPTION OF THE DRAWINGS

The present disclosure will be described hereafter with reference to the attached drawings which are given as non-limiting examples only, in which:

FIG. 1 shows a freight tracking system, in accordance with some embodiments of the present disclosure.

FIG. 2 is a schematic illustration of an example computing system usable to track goods at a piece level, in accordance with some embodiments of the present disclosure.

FIG. 3 is a computing device, in accordance with some embodiments of the present disclosure.

FIG. 4 is a database entry for tracking goods, in accordance with some embodiments of the present disclosure.

FIG. 5 shows database entries for tracking goods, in accordance with some embodiments of the present disclosure.

FIG. 6 shows a schematic illustration of a rules engine, in accordance with some embodiments of the present disclosure.

FIG. 7 shows a flow chart illustrating a method for piece level tracking an order of goods, in accordance with some embodiments of the present disclosure.

FIG. 8 shows a flow chart illustrating a method for defining a rules engine, in accordance with some embodiments of the present disclosure.

FIG. 9 shows a flow chart illustrating a method for performing a piece level action at a checkpoint, in accordance with some embodiments of the present disclosure.

FIG. 10 shows a flow chart illustrating a method for assigning attributes for pieces, in accordance with some embodiments of the present disclosure.

FIG. 11 shows a flow chart illustrating a method 1100 for displaying a tracking record, in accordance with some embodiments of the present disclosure.

FIG. 12 shows an order information user-interface, in accordance with some embodiments of the present disclosure.

FIG. 13 shows an accepting goods user-interface, in accordance with some embodiments of the present disclosure.

FIG. 14 shows a goods level information user-interface, in accordance with some embodiments of the present disclosure.

FIG. 15 shows a piece ID details user-interface, in accordance with some embodiments of the present disclosure.

FIG. 16 shows a piece ID action user-interface, in accordance with some embodiments of the present disclosure.

FIG. 17 shows a piece ID history user-interface, in accordance with some embodiments of the present disclosure.

FIG. 18 is a flowchart of an implementation of the piece level tracking service, in accordance with some embodiments of the present disclosure.

FIG. 19 is a flowchart of an implementation of the piece level tracking service, in accordance with some embodiments of the present disclosure.

FIG. 20 is a flowchart of an implementation of the piece level tracking service, in accordance with some embodiments of the present disclosure.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

This disclosure relates generally to piece level tracking of goods shipped in a freight context. A feature of shipping goods in a freight context is that a delivery from a specific shipper to a specific consignee can have many pieces (e.g. packages) as part of an order associated with an air waybill. These pieces can be tracked at a goods level. The goods level includes information about how many pieces are in an order and can also track when pieces are split. The goods level may also include characteristics of the goods overall—e.g., a total weight, total volume, or other characteristics. In some circumstances, all of the pieces in an order are shipped together from the source to the destination. In other circumstances a split occurs where pieces are transported separately. For example, pieces sent from a source to a destination can be assigned to different flights resulting in a split of the shipment. The goods level of tracking includes information about when and where a split occurs and can include information about how many pieces are in each split group. However, tracking at the goods level does not include information about individual pieces. Examples of individual information includes individual weight, volume, contents, and other information specific to a package, or piece. Tracking at a piece level allows for the capturing of this, and related, information which in turn can be provided to various users. Accordingly, the granularity at which goods may be tracked during freight shipment is improved.

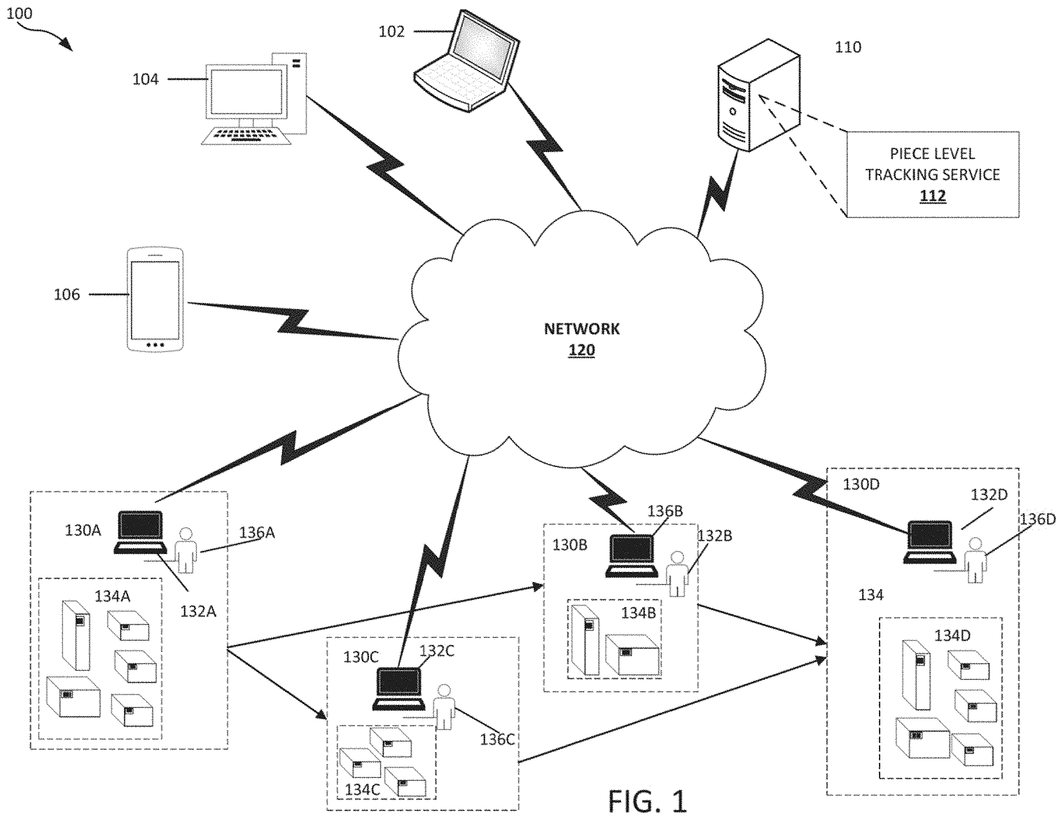

FIG. 1 shows a freight tracking system 100, in accordance with some embodiments of the present disclosure. The freight tracking system 100 includes computing devices 102, 104, and 106, a server 110, a network 120 and shipment checkpoints 130A, 130B, 130C, and 130D.

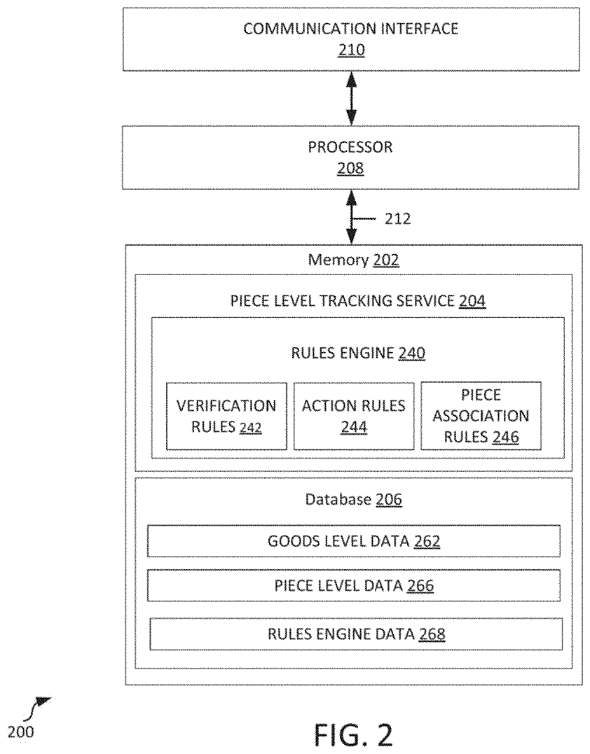

In the example shown the server 110 can represent a processing server or a plurality of processing servers. The sever includes a piece level tracking service 112. The piece level tracking service 112 is a service providing tracking for individual pieces in the shipment of goods. The piece level tracking service 112 is illustrated and described in reference with FIG. 2. The server is connected to the network 120.

In some cases, the network 120 represents an at least partially public network such as the Internet. The network 120 connects computing devices 102, 104, 106 with the server 110.

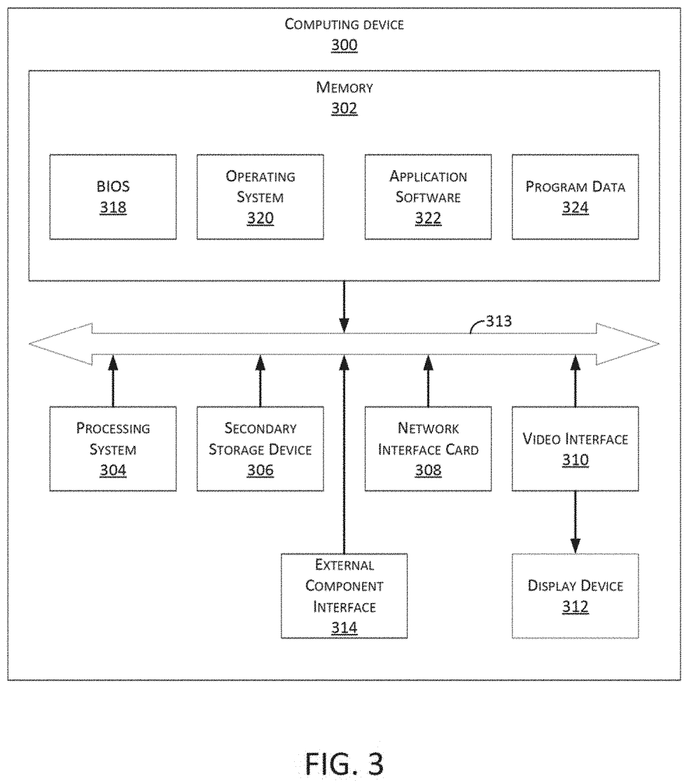

In the example shown, computing devices 102, 104, and 106 are configured to access and modify data using the piece level tracking service 112. In some cases, one or more of the computing devices 102, 104, and 106, may download tracking information for an order of goods. The computing devices 102, 104, and 106 may also modify various tracking configurations stored on server 110. The computing devices 102, 104, and 106 can be used by a variety of users including, freight shipping customers, carriers, or freight logistic administrators. An example of computing devices 102, 104, and 106 is illustrated and described in reference to FIG. 3.

The shipping checkpoints 130A-D each correspond to a way point location for goods shipped in a freight context. In the example shown, checkpoint 130A is a source location. Checkpoint 130A could be a warehouse where the goods are held when an order is placed. In another example, checkpoint 130A is a source airport for an order of goods. In the example shown, checkpoint 130D is a destination location. In some examples, 130D is a destination store or warehouse. In another example, 130D is a destination airport.

Checkpoints 130B and 130C are midpoints that one or more pieces pass through from the source checkpoint 130A to destination checkpoint 130D. In some examples, checkpoints 130B and 130C are airport locations where pieces are transferred from one flight to another flight. Other such possible checkpoints 130B and 130C locations include check points for goods shipped by plane, truck, or other airlines.

The example shown includes four checkpoints 130A-D, however, other numbers of locations are within the scope of this disclosure, for example one, two, four, or more locations.

In the example shown, each of the checkpoints 130A-D includes a computing device 132A-D, and may receive pieces 134A-D, operable by a respective user 136A-D. The computing device is connected to the network 120 and is configured to update the piece level tracking service 112. The pieces 134 can include any number of pieces received at the checkpoints 130A-D. The pieces 134 may all be from one order for shipping goods or from many different orders. In the example shown the pieces 134A are split into pieces 134B and 134C. The pieces 134B are sent to checkpoint 130B and the pieces 134C are sent to checkpoint 130C. The piece level tracking service 112 provides tracking for specific pieces when the pieces 134A are split.

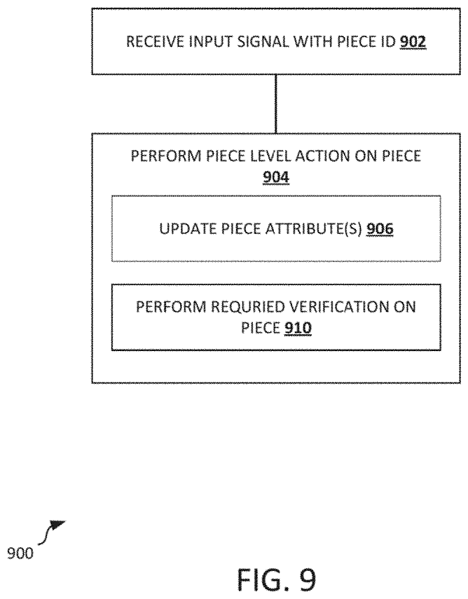

In some examples, users 136A-D at checkpoints 130A-D are involved in the entry of information from the pieces 134 using the computing device 132 to update stored information in the server 110 through the network 120. An example of computing devices 132 is shown in FIG. 3. An example method of receiving an input at a checkpoint is illustrated and described in reference to FIG. 9.

FIG. 2 is a schematic illustration of an example computing system 200 usable to track goods at a piece level, according to an example embodiment of the present disclosure. In general, the computing system 200 includes a processor 208 communicatively connected to a memory 202 via a data bus 212. The processor 208 can be any of a variety of types of programmable circuits capable of executing computer-readable instructions to perform various task, such as mathematical and communication tasks. The memory 202 can include any of a variety of memory devices, such as using various types of computer-readable or computer storage media, as also discussed above. In the embodiment shown, the memory 202 stores a piece level tracking service 204 discussed in further detail below. The computing system 200 can also include a communication interface 210 configured to receive and transmit data, for example to access data in an external database, or to serve a web interface useable to process or configure the piece level tracking data.

In some embodiments, the piece level tracking service 204 is configured to process tracking goods and various shipping functions. The piece level tracking service 204 is an example embodiment of the piece level tracking service 112 illustrated and described in reference to FIG. 1. In the example embodiment shown, the piece level tracking service 204 includes a rules engine 240. The rules engine 240 includes verification rules 242, action rules 244, and piece association rules 246. The memory 202 may also include or interact with a database 206, for example, using queries. The database 206 may store goods level data 262, piece level data 266, and rules engine data 268.

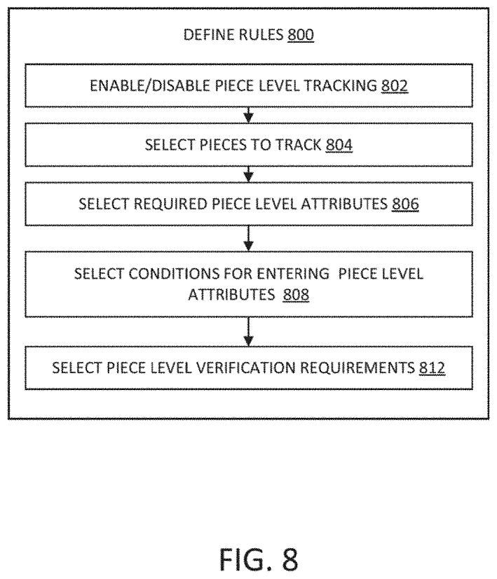

In example embodiments, the rules engine 240 can be configured to control how piece level tracking is used including indicating which types of shipments or at which locations piece level tracking is required. The rules engine 240 can control under which conditions piece level data needs to be entered or associated. The rules engine 240 may also indicate which actions are prohibited to maintain piece-level tracking. The rules engine 240 may further be configured to enforce mandatory attributes and mandatory verification requirements. Additionally, the rules engine 240 may describe how validation errors are managed. For example, the rules engine 240 can cause an error message, cause a warning, or can cause the automatic dropping of the Piece ID Association. The rules engine 240 is flexible allowing many different clients to configure the rules engine for their specific purposes. An example of defining a rules engine is illustrated and described in reference to FIG. 8.

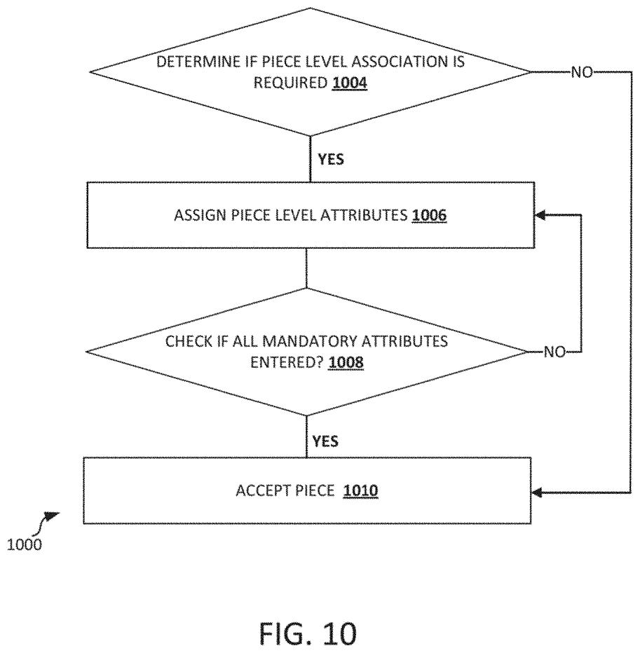

The example shown includes verification rules 242. The verification rules 242 can be used to check various verification requirements. The verification requirements can be defined by the rules engine 240 and include a list of which attributes are mandatory for verification when the rules engine 240 indicates verification is required. In some examples, the verification rules 242 may mark a piece as verified when all the mandatory attributes are entered. In another example, a user manually marks the piece ID as verified when the verification rules 242 indicate that the mandatory attributes are available for the piece ID. In other examples the verification rules 242 may require the weight or volume of one or more pieces to be specified before assigning the associated piece to a route. An example method using a rule defined by verification rules 242 is shown in reference to FIG. 10.

The example shown further includes action rules 244. The action rules 244 may be performed by a cargo tracking system. In some examples, the action rules are used to update tracking data, for example goods level data 262 and piece level data 266, in response to various actions taking place on the shipment. Examples of piece level actions defined by the action rules 244 include change of piece location, assigning piece to a flight, removing a piece from flight, goods status changes, piece checked in, and association/disassociation of piece IDs from the shipment. In some embodiments, the rules engine 240 is checked to verify the impact of different actions on piece level tracking. In some examples the rules engine 240 is defined to prohibit the cargo tracking system from performing specific actions. For example, the rules engine 240 could define a rule which prohibits the assignment of a piece to a flight before piece ID association. An example method for using a rule defined by the action rules 244 is described in FIG. 9.

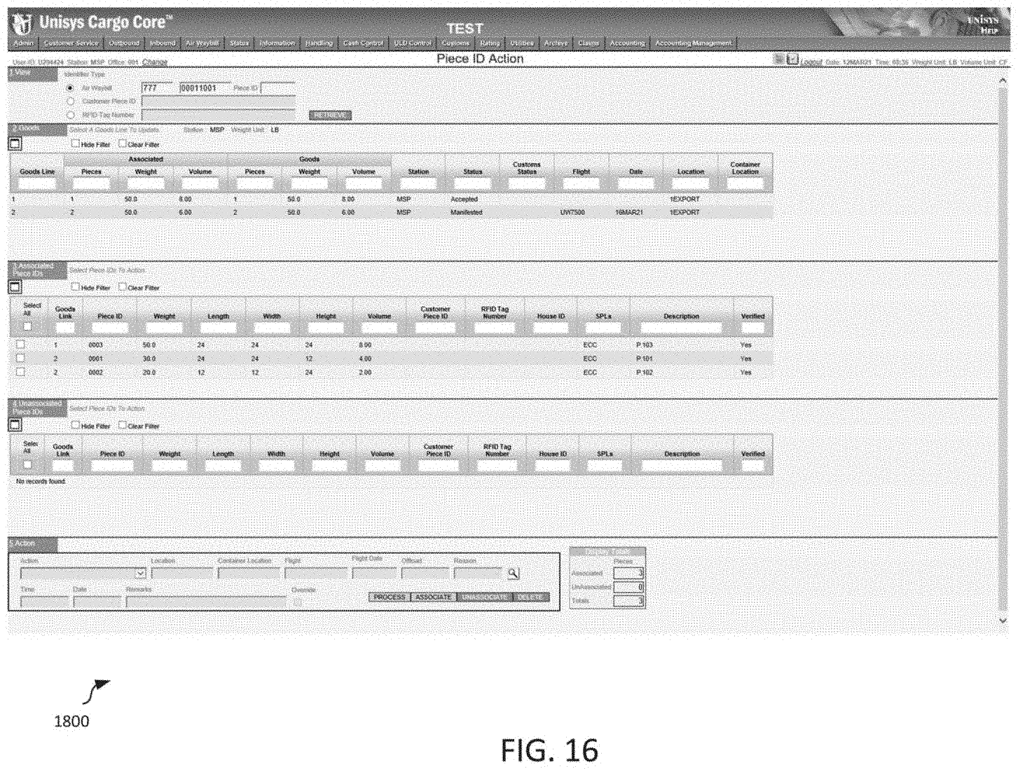

The example shown includes piece association rules 246. The piece association rules 246 are used to define if generic goods pieces need to be associated with piece IDs before the goods can be actioned. For example, an example rule may define whether, if the user actions three pieces, the user needs to specify what each individual piece is or whether they can action the three pieces as a group. An example of specifying each piece includes assigning a piece ID (i.e. 0001, 0002, and 0003). In some examples, the piece association rules indicate which attributes are mandatory in order to verify a piece ID. In some examples, another rule is used to indicate if the pieces needs to be verified in order to perform an action on the piece. Attributes associated with a piece include piece ID, piece weight, piece volume, piece dimensions, customer ID, RFID tag number, and special shipping/handling codes. In some examples, piece IDs are associated automatically, in other examples, a carrier or customer selects and associates the piece IDs during the piece association process. In other examples, the association rules 246 may require that the pieces have correctly been associated with a piece ID. An example method for the action rules 244 are described in reference to FIG. 10. An example user-interface for piece association is described and illustrated in reference to FIG. 16.

In example embodiments, the database 206 is stored in memory 202. In the example shown the database 206 includes goods level data 262, piece level data 266, and rules engine data 268.

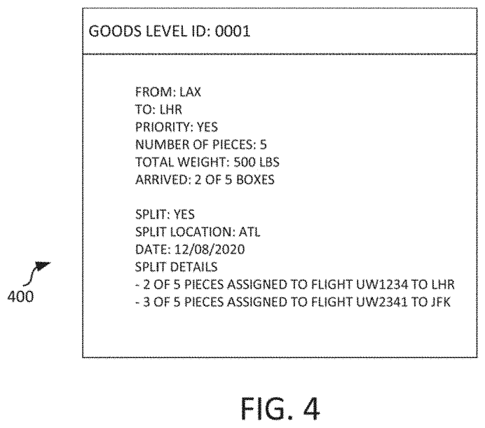

The goods level data 262 can include entries for tracking a shipment at a goods level. The goods level data 262 may form associations with the piece level data 266. An example of a goods level data entry is described in reference to FIG. 4.

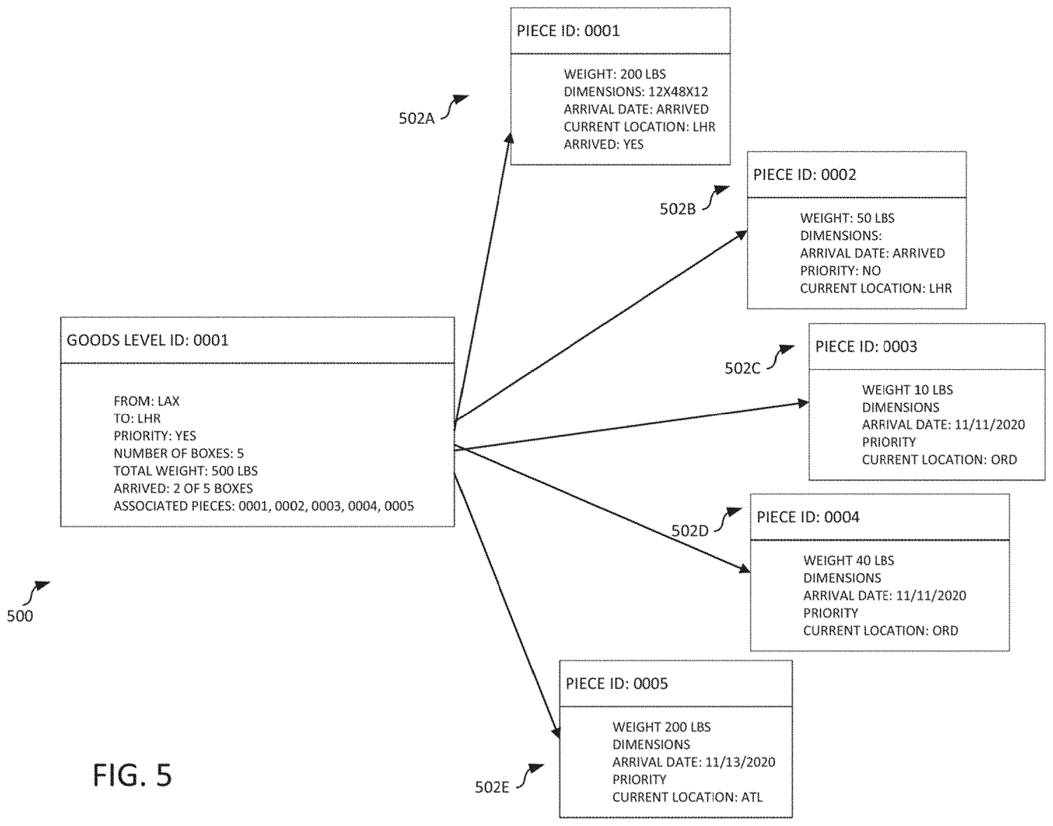

The piece level data 266 can include entries for tracking a shipment at a piece level. In some examples piece level data 266, includes weight, volume, dimensions, piece status, piece location, and arrival date. An example of a piece level entry is described in reference to FIG. 5.

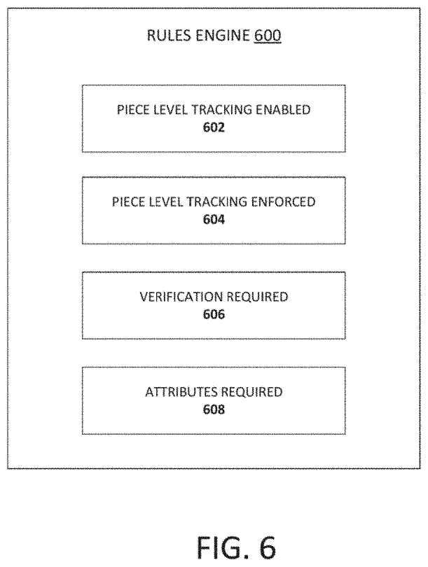

The rules engine data 268 includes entries defining the values checked by the rule. A plurality of configurations of the rules engine 240 can be stored as entries in the rules engine data 268. In some examples, the rules engine data 268 is stored independently of the shipping information and is managed by a system administrator. In some examples, an airline, either independently or collaboratively, manages the rules engine data 268 with the system administrator. An example of a configuration of rules is described in reference to FIG. 6.

In the example of FIG. 3, the computing device 300 includes a memory 302, a processing system 304, a secondary storage device 306, a network interface card 308, a video interface 310, a display unit 312, an external component interface 314, and a communication medium 313. The memory 302 includes one or more computer storage media capable of storing data and/or instructions. In different embodiments, the memory 302 is implemented in different ways. For example, the memory 302 can be implemented using various types of computer storage media.

The processing system 304 includes one or more processing units. A processing unit is a physical device or article of manufacture comprising one or more integrated circuits that selectively execute software instructions. In various embodiments, the processing system 304 is implemented in various ways. For example, the processing system 304 can be implemented as one or more physical or logical processing cores. In another example, the processing system 304 can include one or more separate microprocessors. In yet another example embodiment, the processing system 304 can include an application-specific integrated circuit (ASIC) that provides specific functionality. In yet another example, the processing system 304 provides specific functionality by using an ASIC and by executing computer-executable instructions.

The secondary storage device 306 includes one or more computer storage media. The secondary storage device 306 stores data and software instructions not directly accessible by the processing system 304. In other words, the processing system 304 performs an I/O operation to retrieve data and/or software instructions from the secondary storage device 306. In various embodiments, the secondary storage device 306 includes various types of computer storage media. For example, the secondary storage device 306 can include one or more magnetic disks, magnetic tape drives, optical discs, solid state memory devices, and/or other types of computer storage media.

The network interface card 308 enables the computing device 300 to send data to and receive data from a communication network. In different embodiments, the network interface card 308 is implemented in different ways. For example, the network interface card 308 can be implemented as an Ethernet interface, a token-ring network interface, a fiber optic network interface, a wireless network interface (e.g., WiFi, WiMax, etc.), or another type of network interface.

The video interface 310 enables the computing device 300 to output video information to the display unit 312. The display unit 312 can be various types of devices for displaying video information, such as an LCD display panel, a plasma screen display panel, a touch-sensitive display panel, an LED screen, a cathode-ray tube display, or a projector. The video interface 310 can communicate with the display unit 312 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 314 enables the computing device 300 to communicate with external devices. For example, the external component interface 314 can be a USB interface, a FireWire interface, a serial port interface, a parallel port interface, a PS/2 interface, and/or another type of interface that enables the computing device 300 to communicate with external devices. In various embodiments, the external component interface 314 enables the computing device 300 to communicate with various external components, such as external storage devices, input devices, speakers, modems, media player docks, other computing devices, scanners, digital cameras, and fingerprint readers.

The communication medium 313 facilitates communication among the hardware components of the computing device 300. In the example of FIG. 3, the communications medium 313 facilitates communication among the memory 302, the processing system 304, the secondary storage device 306, the network interface card 308, the video interface 310, and the external component interface 314. The communications medium 313 can be implemented in various ways. For example, the communications medium 313 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

The memory 302 stores various types of data and/or software instructions. For instance, in the example of FIG. 3, the memory 302 stores a Basic Input/Output System (BIOS) 318 and an operating system 320. The BIOS 318 includes a set of computer-executable instructions that, when executed by the processing system 304, cause the computing device 300 to boot up. The operating system 320 includes a set of computer-executable instructions that, when executed by the processing system 304, cause the computing device 300 to provide an operating system that coordinates the activities and sharing of resources of the computing device 300. Furthermore, the memory 302 stores application software 322. The application software 322 includes computer-executable instructions, that when executed by the processing system 304, cause the computing device 300 to provide one or more applications. The memory 302 also stores program data 324. The program data 324 is data used by programs that execute on the computing device 300.

Although particular features are discussed herein as included within a computing device 300, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer storage media does not include, e.g., solely a carrier wave or other propagated or modulated data signal. In some embodiments, the computer storage media includes at least some tangible features; in many embodiments, the computer storage media includes entirely non-transitory components.

The computing device 300 is an example of the computing devices 102, 104, 106, 132A-D, and server 110 as illustrated and described in reference to FIG. 1.

FIG. 4 shows a database entry for tracking goods, in accordance with some embodiments of the present disclosure. The database entry shown is a goods level entry 400 and contains information about a shipment at a goods level. In some embodiments the goods level database entry is stored on a computing device or server, such as the computing devices described previously.

In the example shown, the goods level entry 400 contains various information about a shipment at a goods level. This information may include the route the goods have been assigned, a priority level, a number of pieces, a weight of pieces and an arrival status. This information can also include information about whether a shipment is split. If a split of a shipment occurs goods level entry 400 can include where and when such split occurred, the number of pieces split and tracking information about the split goods. A person of ordinary skill of the art would recognize that there are many more features which could be recorded at a goods level and stored with the goods level entry 400.

Goods level entry 400 is an example of an entry of goods level data 262 stored in the database 206 as described in the example of FIG. 2. In some embodiments these entries are stored on a computing device or server. For example, these entities could be stored at computing devices 102, 104, 106 or server 110 as shown in the example of FIG. 1.

FIG. 5 shows a goods level entry 500 and piece level entries 502A-E, in accordance with some embodiments of the present disclosure. The goods level entry 500 in some embodiments includes the group level information described in greater detail in reference to FIG. 4. The goods level entry 500 can also include associations to a plurality of piece level entries 502A-E.

The associated piece level entries 502A-E include specific piece attributes for each associated piece such that a user can determine the status a specific piece that is of interest. Examples of piece-level attributes include, location, special handling codes, weight, volume and/or dimensions. The information stored in the piece level entries 502A-E can be created with a piece ID from the piece association rules 246, configured by the rules engine 240, and updated by the action rules 244, as shown in the example of FIG. 2.

The plurality of piece level entries 502A-E are examples of piece level data 266, as shown in the example of FIG. 2. In some embodiments, goods level entry 500 and the piece level entries 502A-E are stored on a computing device or server. For example, these entities could be stored at computing device 106 or server 110 of FIG. 1.

FIG. 6 shows an example schematic illustration of a rules engine 600. The rules engine 600 can include a piece level tracking enabled rule 602, a piece level tracking enforced rule 604, a verification required rule 606 and an attribute requirement rule 608. The rules engine 600 is another example for the rules engine 340 as shown in the example of FIG. 3. In some examples, the rules engine 600 is configured manually by the system administrator or an airline.

The rules engine 600 includes a piece level tracking enabled rule 602. The piece level tracking enabled rule 602 will notify the shipping system whether a piece should be tracked at the piece level. In some examples, the piece level tracking enabled rule 602 is defined for a specific type of shipment. For example, a product code or special handling code of a shipment being shipped could be defined.

The rules engine 600 includes a piece level tracking enforced rule 604. In some examples, the piece level tracking enforced rule 604 will determine whether piece level tracking is mandatory, optional, or not enforced at a particular location and for a particular user action.

The rules engine 600 includes a verification required rule 606. The verification required rule 606 defines whether a piece needs to be verified.

The rules engine 600 includes an attribute requirement rule 608. The attributes required rule defines what attributes are required to mark a piece as verified. In the typical example, the attribute requirement rule 608 only defines attributes required for verification when the verification required rule 606 is set to require verification.

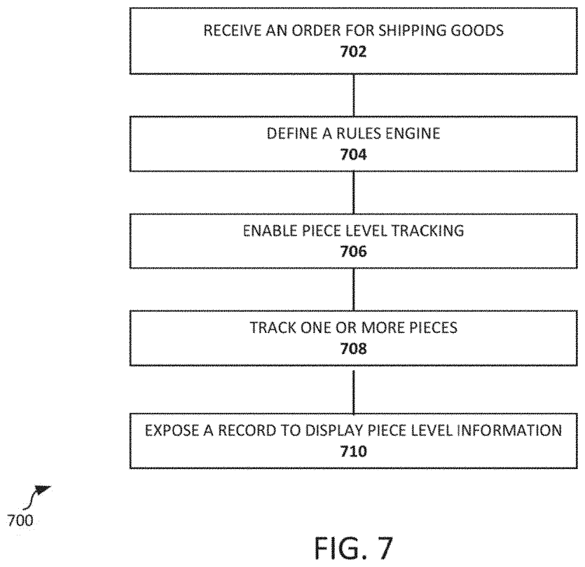

FIG. 7 is a flow chart illustrating an example method 700 for piece level tracking an order of goods. In this example method 700 includes the operations 702, 704, 706, 708, and 710.

At operation 702, an order is received for shipping goods. The order can be for goods in bulk and defined at a goods level. The order is associated with a plurality of pieces. In the typical example, the order is placed to move shipments from one airport to another airport. In some examples the order may be placed by a customer buying goods in bulk from a manufacture. In others the order may be placed by a manufacturer who is shipping the goods to fulfill an order received by the manufacturer.

At operation 704, the rules engine is executed. The airline defines the rules used when processing the shipment to control how piece level tracking is used. This includes indicating which types of shipments are tracked at the piece level, which stations piece level tracking is required, under which conditions piece level data needs to be entered or associated. The rules engine can also be defined to enforce mandatory attributers and mandatory verification requirements. Additionally, the rules engine may describe how validation errors are managed. For example, the rules engine can cause an error message, cause a warning, or drop the piece association. The rules engine can be flexible allowing many different clients to configure the rules engine to meet their specific goals for piece level tracking. An example embodiment of defining a rules engine is illustrated and described in the example of FIG. 8.

At operation 706, piece level tracking is enabled. Enabling piece level tracking can be done automatically by the piece level tracking services. In a typical example, piece level tracking is enabled or disabled based on the air waybill attributes of an order. For example, piece level tracking may be enabled or disabled based, at least in part, on the product code or the routing of a shipment. In these examples, once an airline sets up the rules, all air waybills meeting the defined criteria have piece level tracking enabled and a customer has no choice for whether a piece is tracked at a piece level. In another example, the system administrator can enable or disable piece level tracking based on the importance of an order. Enabling piece level tracking configures the rules engine to support piece level tracking.

At operation 708, a piece is tracked. A piece can be tracked by receiving piece level inputs at a checkpoint. Examples of receiving piece level inputs can be received from a scanner, an RFID tag, and a GPS tracker. Once a piece level input is received the piece level tracking service, in some examples, updates piece level details which are of interest to a user. By updating the details after receiving a piece level entry the piece level tracking service allows a user to track a piece at the piece level.

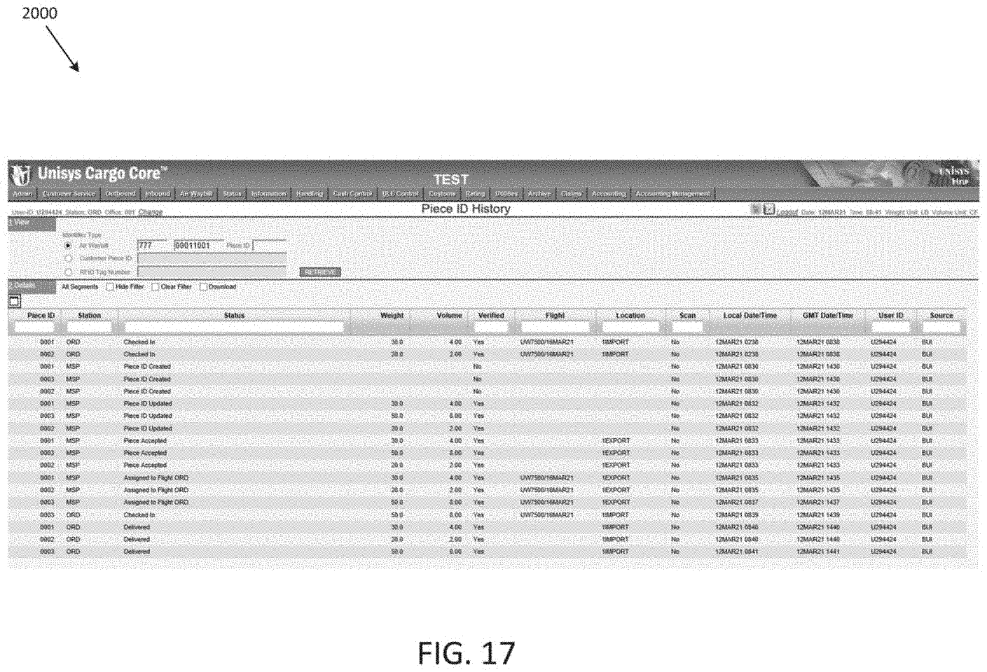

At operation 710, a record of a piece is exposed. The record provides piece level details which are of interest to a user. One example of such a detail is the current location or status of a piece. Another example is the weight and volume for the piece. Examples of such a record is shown in reference to FIG. 17.

FIG. 8 is a flow chart illustrating an example method 800 for defining a rules engine. The method 800 is one example method of the operation 704 illustrated and described in FIG. 7. The method 800 includes possible configurations 802, 804, 806, 808, and 812 to a rules engine.

The various configuration operations 802, 804, 806, 808, and 812 can be done automatically by the piece level tracking service. In a typical example, the configuration is done by an airline for a complete system for shipping. In some of these examples the airline works with a piece level tracking administrator to configure a rules engine.

Configuration operation 802 enables or disables piece level tracking. In the typical example, turning on or off piece level tracking is done using the tracking service changing a parameter. When the parameter is turned off the tracking service operates without checking the configuration of the rules engine. When piece level tracking is enabled the rules engine is checked whether tracking for the specific order is turned on (804) and whether for this order each piece is tracked, including when an order is split identifying the specific pieces included in each split of the order. In some examples, configuration operation 802 may be selectable to disable piece level tracking.

In some examples, piece level tracking is expensive and requires specific infrastructure. In such examples piece level tracking may only be enabled for specific pieces of interest. In such examples, configuration operation 804 is used to identify which orders are of interest for piece level tracking. In one example a customer may only want to enable piece level tracking for high value orders. In another example, a waypoint (such as an airport) may not include the proper equipment and/or procedures to implement piece level tracking, so the carrier may disable piece level tracking when packages are routed through that checkpoint.

Configuration operation 804 is defined by the system administrator. In the typical example, a shipping administrator will perform the configuration operation 804 based on inputs from an airline. In some examples, the configuration operation 804 to enable/disable piece level tracking is configured automatically from the action rules 244, as described in the example of FIG. 2.

In some embodiments, configuration operation 804 selects which pieces are tracked at a piece level. In some examples, when piece level tracking is enabled in configuration operation 802 all pieces in the order are automatically selected for piece level tracking. In another example, if piece level tracking is disabled in configuration operation 802, then the configuration operation 804 is not available. In another example, when piece level tracking is enabled in configuration operation 802, then configuration operation 804 allows for the selection of the type of shipments for which the system will track at a piece level.

In some examples, piece level tracking is only desirable for a portion of the pieces in an order. In some examples, if piece level tracking is enabled for a station, then piece level tracking is required for all pieces that are in bulk. An exception may exist in some examples if the piece is part of a shipper loaded ULD.

In another example the action rules 244 described in the example of FIG. 2 may automatically select a portion of pieces in an order based on the routing of different pieces. For example, certain checkpoints are allowed to ignore tracking requirements. For example, a shipment going from a station in Los Angeles to a station in Atlanta and then to a station in Paris can require piece level input at Los Angeles and Paris but the intermediate station (Atlanta) can ignore the piece level tracking requirement. In this example, when a piece is split at the intermediate Atlanta station, piece level IDs will be dropped, and the piece level IDs will be reassociated at the piece level tracking enforced station, in this example at the station in Paris.

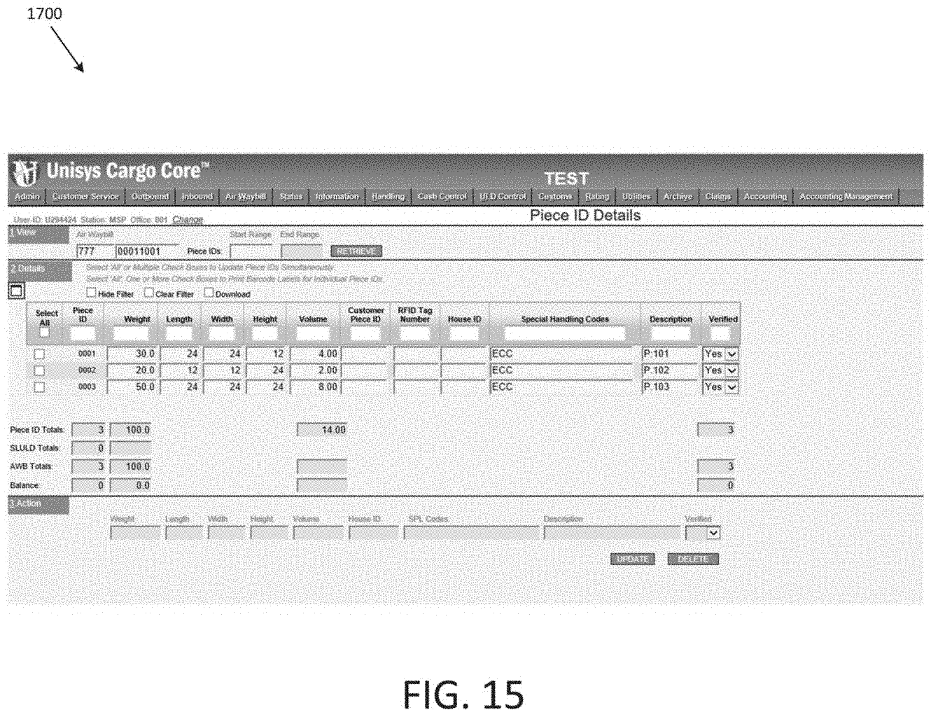

Configuration operation 806 selects required piece level attributes. The rules engine, in some examples, will require a piece ID for each piece. The rules engine can, for example, require weight and/or dimensions attributes. For example, the weight attribute can be required for piece level tracking for the shipment of goods by air because the airlines may require such information when assigning pieces to flights. An example of a user-interface for entering piece level attributes is shown and described in reference to FIG. 15.

Configuration operation 808 determines the conditions for entering piece level attributes. Defining the rules engine includes setting conditions for when piece level attributes must be entered. In one example, the piece level attributes must be entered before the carrier accepts the goods. For example, the carrier may not have the resources to enter piece level details and will require such details be entered by a customer before accepting goods. In another example, piece level attributes are not required until the goods are split. For example, a user may only wish to enter piece level attributes when the pieces of an order are split. In the typical example, the attributes are entered by staff at a checkpoint. For example, the attributes may be entered by the airline staff before the shipments are assigned to a flight.

Configuration operation 812 selects piece level verification requirements. The rules engine can be defined to require certain piece level details to get verified at selected checkpoints. One example of a verification requirement is weight. A piece may have its weight verified at various checkpoints. A verification requirement may also require the input of a piece's volume or dimensions. Another example of a verification requirement is that certain details of interest are entered at a specific checkpoint. Any piece level detail which is trackable can be verified at different stations or events.

In some examples, the rules engine is flexible allowing for a wide variety of configurations or customizations. For example, in some instances all of the above configuration operations 802, 804, 806, 808, and 812 are configured. In other instances, none of the configurations are set. In some examples, any combination of the above configurations can be set to meet a carrier or customers needs.

FIG. 9 is a flow chart illustrating an example method 900 for performing a piece level action at a checkpoint. In this example the method 900 includes the operations 902 and 904. The operation 904 includes possible sub-operations 906, and 910.

At operation 902, an input signal with a piece ID is provided. The input of data at the piece level can be done when a piece arrives at a checkpoint. The input of this data can be done by scanning each box. For example, each piece may include a bar code which uses an industry identification standard (e.g. airline industry standard IATA). Other examples of data input include RFID tags and scanners, and GPS trackers. In some examples, the input of data can be done implicitly. For example, if an order is not split then each piece ID can stay associated with the order and tracked as a group.

At operation 904, a piece level action is performed. A piece level action is any action performed on an individual or group of pieces. The piece level action may include updating and storing details about a piece. A piece level action also include routing a piece to a certain location. In some examples, operation 904 prohibits specific actions based on piece-level identification and/or verification. For example, piece ID association and/or verification might be mandatory before the movement into a container or before flight assignment. In another example, operation 904 may handle an error condition. The operation 904 can perform an auto correction, raise an error message requiring piece-level identification before actioning, a warning, or the dropping of piece IDs (at stations that are not piece level tracking enabled). Sub-operations 906 and 910 are examples of piece level actions.

At the sub-operation 906, the piece location attribute is updated. Examples of attributes which could be updated include: change of location, flight, or other transportation assignment, whether the piece was removed from a flight, status change of the piece, whether the piece was checked-in, or whether the piece is no longer in transit. In some examples, each of these actions are recorded and a piece history is maintained.

In some examples, updating piece level attributes updates the attributes for several pieces automatically. For example, where there is no split in an order the associated pieces location attribute can be updated automatically when the order arrives at a checkpoint. In some examples pieces are automatically combined when received at a single checkpoint. A piece level action can associate the combined pieces which allows the piece level tracking service to track the pieces as a combined unit.

Pieces are sometimes split at a checkpoint. In some instances, the split pieces may not have piece level association (e.g. if piece level association is not required until the goods are split). In such instances the piece level action can create a piece level association with the split pieces. In other instances, the piece level action will raise an error message which needs to be corrected by the user before the status change can be recorded. In other instances, there is a split of pieces at a checkpoint which is not enabled with piece level tracking. In this instance the piece level tracking service may drop the piece ID association at this station and proceed with the regular group action processing.

At sub-operation 910, the piece is verified. In one example, the verification is a yes/no flag set by a user, or a customer prior to accepting shipment. The rules engine will then check what attributes need to be present in order to set the verification flag to Yes. Additionally, the rules engine may define rules to prevent specific actions without verified Piece IDs.

In some examples, the system may perform an internal integrity check. In these examples attributes are automatically corrected by comparing attributes associated with all pieces of a group with the attributes of the group. Examples of attributes that can be automatically checked include weight and volume. For example, sub-operation 910 can ensure that the sum of the weight and volume values recorded for all associated Piece IDs match the weight and volume values of the corresponding group.

In one example, multiple pieces can be verified at the same time. For example, if multiple piece ID from the same order are received at a checkpoint at the same time a total weight and volume of the pieces can be checked at the same time.

FIG. 10 is a flow chart illustrating an example method 1000 for assigning attributes for pieces. In this example the method 1000 includes the operations 1004, 1006, 1008, and 1010.

At operation 1004, it is determined whether piece level association is required. The piece level tracking service will call the rules engine and determine when piece level association is required. Piece level association includes entering required attributes as specified by the rules engine.

In some examples, piece level association may be required before the goods are accepted. For example, a carrier may require piece level association is completed before accepting goods.

In other examples, piece level association is not required until after the goods are accepted. For example, the piece level association may occur at a later checkpoint which supports piece level tracking. In some examples, piece level association occurs using a webservice after the goods are accepted or using a scanner. If piece level association is not required at operation 1004 the piece is accepted at operation 1010.

At operation 1006, piece level attributes are assigned. In some examples, to create piece level associations piece level attributes are assigned to each piece selected for tracking. Examples of such attributes include piece ID, weight, dimensions, and any other attribute related to a piece. The piece level attributes can be entered by a user on a web service or may be input using a scanner. An example user-interface for entering piece level attributes is illustrated and described in reference to FIG. 15.

At operation 1008, there is a check if all mandatory piece level attributes are entered. The piece level tracking service will call the rules engine to determine whether the mandatory attributes have been recorded. In some examples, the rules engine is configured to require certain attributes before acceptance. For example, an order which is shipped by an airline may require a weight entered to help the airline make decisions on which pieces are assigned to which flight for weight restriction and fueling decisions.

At operation 1010, the piece is accepted. In some examples, a carrier accepts a piece after all mandatory piece level attributes are entered. In other examples, the carrier accepts the piece and automatically enters piece level attributes at the same time. In other examples, the piece level attributes are entered after the piece is accepted, for example, piece level attributes may be entered when an order is split by a carrier using a scanner, or a user using a web service.

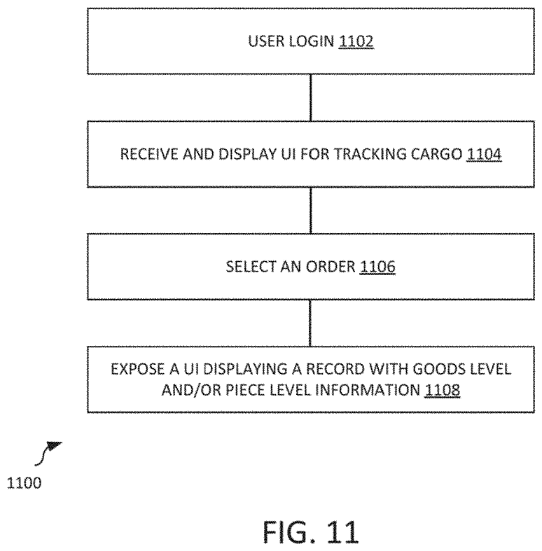

FIG. 11 is a flow chart illustrating an example method 1100 for displaying a tracking record. The method 1100 includes operations 1102, 1104, 1106, and 1108.

At operation 1102, a user logs in to the piece level tracking service. In some examples, a user can login to the service for different computing devices, such as computing devices 102, 104, and 106 as shown in the example of FIG. 1.

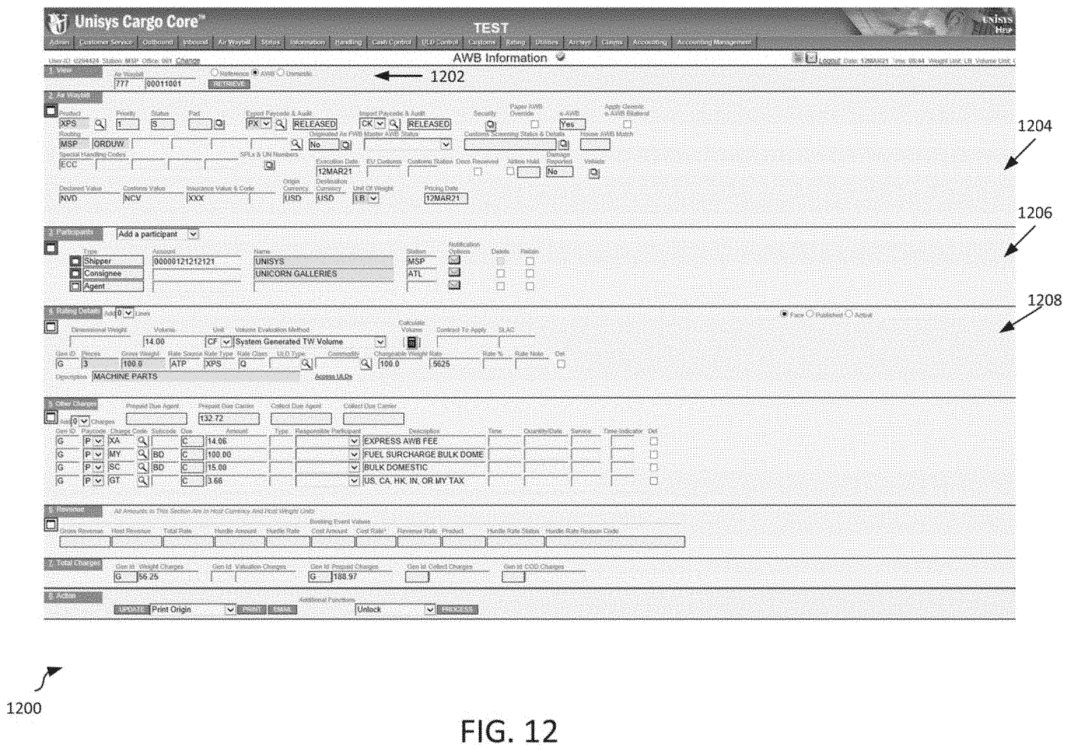

At operation 1104 a user interface (UI) is displayed for tracking cargo. The UI can include providing information at the goods level and at the piece level for one or more orders. Examples of such UIs are shown in FIGS. 12-17.

At operation 1106, the user selects an order. In one example, the user may have a customer ID which is associated with an order, which a user can select. In another example, the user may have an order ID number which the user can use to submit a query for the order.

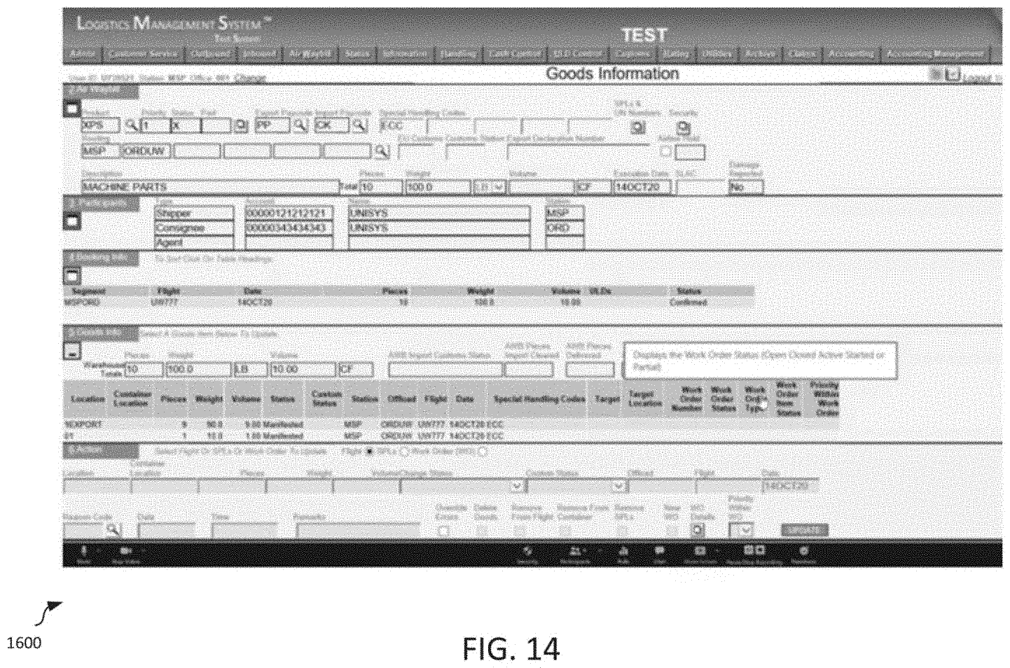

At operation 1108, the order details are exposed. The piece level tracking system will check the rules engine and determine whether piece level tracking is enabled. If piece level tracking is enabled the order details can include piece level details and if piece level tracking is disabled, the order details can include goods level details. An example of a UI presenting goods level detail is shown in the example of FIG. 14. An example of a UI presenting goods and piece level details is shown in the example of FIG. 16.

FIGS. 12-17 are example user-interfaces (UIs) to implement various example features of the piece level tracking service.

FIG. 12 is an example order information user interface (UI) 1200. The user-interface 1200, in some examples, includes a query UI region 1202, an order details UI region 1204, a participant details UI region 1206, and a rating details UI region 1208.

The query UI region 1202 allows a user to retrieve an order. The example shown the order is retrieved by inputting an air waybill number, which in the example shown is a common identifier for shipping goods by air. Once an order is retrieved order details may populate the user-interface 1200.

The order details UI region 1204 includes various details or allows for the entering of details for the retrieved order. Details include the type of product(s), special handling codes, weight, and routing information. A user can update or input one or more of the details presented by the order details UI.

The participant details UI region 1206 presents assigned roles or allows a user to add and select roles. The different participants may have different options which allow them to make modifications to an order.

The rating details UI region 1208 presents a UI to view or input volume and weight details for an order. In the context of air shipment these details may be required before assigning an order to one or more flights.

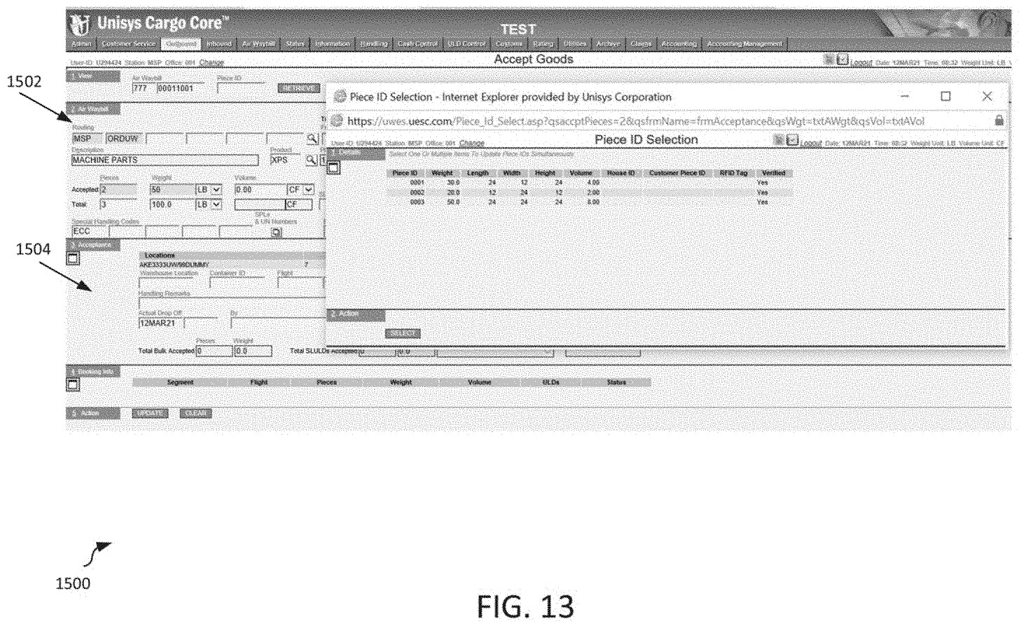

FIG. 13 is an example accepting goods user interface 1500, in accordance with some embodiments of the present disclosure. The user interface 1500 includes accept pieces UI region 1502, and an acceptance UI region 1504. The accepting goods user-interface, in some examples, is used by a carrier to accept one or more pieces that are part of an order.

The accept pieces UI region 1502 allows the user to enter details such as number of pieces, weight of the pieces and volume of the pieces. In the example shown, the accept pieces UI region 1502 allows the user to enter the information at a goods level. In some examples, this information is required before an order is accepted.

The acceptance UI region 1504 allows a user to track the location of the piece and assign the piece to a transportation method. The acceptance UI region 1504 may include information about the availability and capacity of certain routes. This information can include current weight or volume of assigned pieces.

FIG. 14 is an example goods level information user-interface 1600, in accordance with some embodiments of the present disclosure. The goods level information user-interface 1600 presents goods level details. In some examples the user-interface 1600 is displayed when piece level tracking is disabled. In other examples the user-interface 1600 is shown when piece level tracking is enabled but the user is interested in receiving goods level information.

FIG. 15 is an example piece ID details user-interface 1700, in accordance with some embodiments of the present disclosure. The user-interface 1700 allows a user to enter the piece level details for individual pieces within an order. In some examples, the user enters all of the piece level details. In other examples, some details may automatically be entered. For example, the piece weight may auto-populate based on the total weight of all of the pieces, assuming a total weight of the overall order is evenly spread across the pieces. In some examples, a user will have the piece ID details interface 1700 presented before the user can accept goods. The piece ID details user-interface 1700 can also allow a user to verify attributes to a unique piece ID.

In example embodiments, the piece ID details user interface 1700 automatically updates piece level details based on user entries of other piece level details. For example if a shipment of goods has an overall weight of 100 pounds and includes five pieces (packages), each piece ID will be attributed with a piece having a weight of 20 pounds, absent any overriding data. However, if a user overrides a weight on one of those pieces (e.g., to ascribe a weight of 40 pounds to the one package), in some examples, weights of the other pieces are automatically adjusted to accommodate the known weight of the one piece and the overall collection of goods (i.e., by distributing the remaining 60 pounds of weight across the four remaining pieces, at an average weight of 15 pounds per package). Other automatic adjustments may be made as well. For example, overall volume of the goods can also be evenly distributed among the pieces. Additionally, it may be assumed that once dimensions are entered for one piece, those same dimensions are ascribable to the remaining pieces within the order.

FIG. 16 is an example piece ID action user-interface 1800, in accordance with some embodiments of the present disclosure. The user-interface 1800 is an example for showing an order at a goods level and at an associated piece level. The piece ID action user-interface can be used to create or modify associations between goods ID and piece IDs.

In some embodiments, within a piece information region, piece level details may also be edited. As in the example user interface 1700 of FIG. 17, adjustment of piece level details for a particular piece within a shipment of goods may result in adjustment of characteristics of other pieces within the shipment to reconcile the piece weight and/or dimensions with overall weight or dimensions, or other characteristics, of such goods.

In one example a piece ID is scanned but the piece is not yet associated with a goods ID. The piece level tracking service can return an error in response to the piece level scan or a piece level action. In another example, the service can provide a manual association of the piece ID to a goods ID using the piece ID Action function. The unassociated piece ID can be associated with a goods ID automatically.

For example, if at an unassociated piece ID is received and at checkpoint and there is a single unassociated goods candidate the piece ID can automatically be associated with the unassociated goods candidate. In this example, if there is more than one unassociated piece ID or if there is no unassociated goods candidate then the piece level tracking system can raise an error. Other discrepancy error messages could also be raised in response to an unassociated piece ID.

FIG. 17 is an example piece ID history user-interface 2000, in accordance with some embodiments of the present disclosure. The user-interface 2000 allows a user to enter and run a query for a piece which returns the piece history for the piece. The piece history includes presenting details of a piece which is tracked at different times and locations.

In some examples, only events that are recorded at the piece level are included in the piece ID history user-interface 2000. For example, if multiple pieces move locations without a piece-level entry no event will be recorded in the piece ID history function. In this example if all pieces are moved as a group without the scanning or selecting of each individual piece no piece ID history event will be recorded.

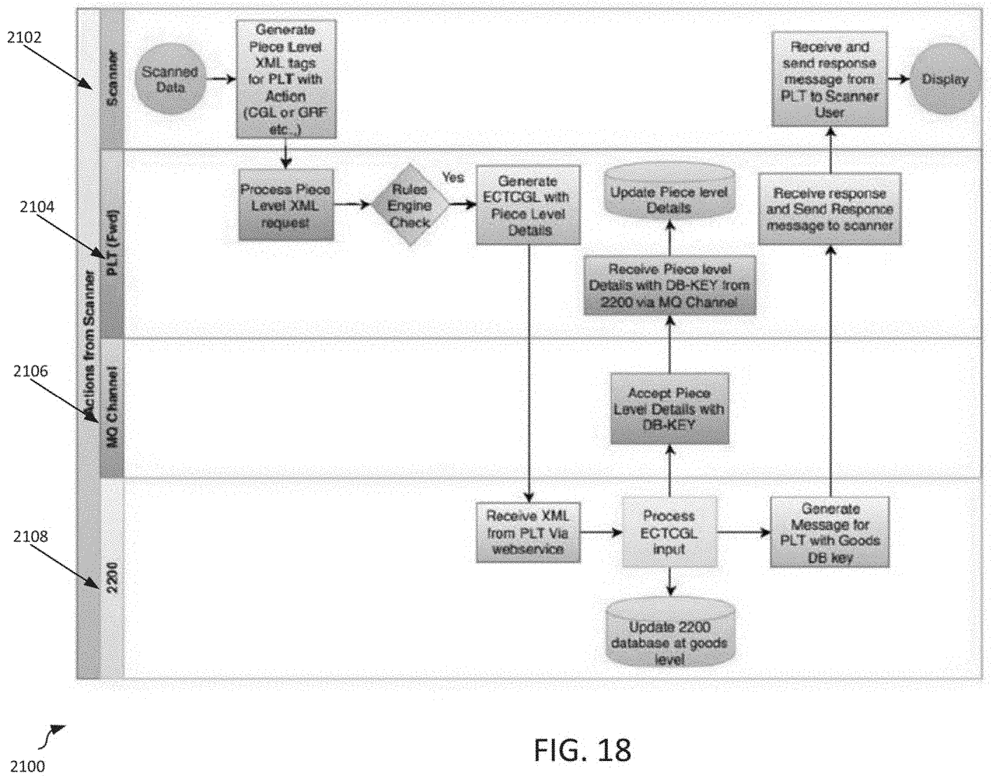

FIGS. 18-20 are example data flows of an implementation of the piece level tracking service, in accordance with some embodiments of the present disclosure.

FIG. 18 is an example flowchart 2100 of an implementation of the piece level tracking service. The flowchart depicts operations that are performed across a scanner layer 2102, a piece level tracking layer 2104, a communication layer 2106, and an operating system layer 2108.

The flowchart 2100 starts with the scanner layer 2102 receiving scanned data. The scanned data can be received using a bar code scanner, an RFID scanner, or a GPS tracker. The scanner layer 2102 then generates piece level tags and/or a request for an action based on the received inputs.

The piece level tracking layer 2104 is generally an application layer that then processes the generated tags to make the piece level action request. The piece level tracking layer 2104 can perform a rules engine check to ensure that the tags and action are allowed. The piece level tracking layer can also generate piece level details which are sent to the operating system layer 2108.

The operating system layer 2108 can receive the piece level details and process the piece level details to update the goods level database and generate a message with the goods database key (DB-Key). The piece level tracking layer 2104 can receive piece level details with DB-Key using the communication layer 2106.

The piece level tracking layer can update the piece level details in a database. The piece level tracking layer 2104 can also receive a message from the operating system layer 2108 which it can send to the scanner layer 2102 to present on a display.

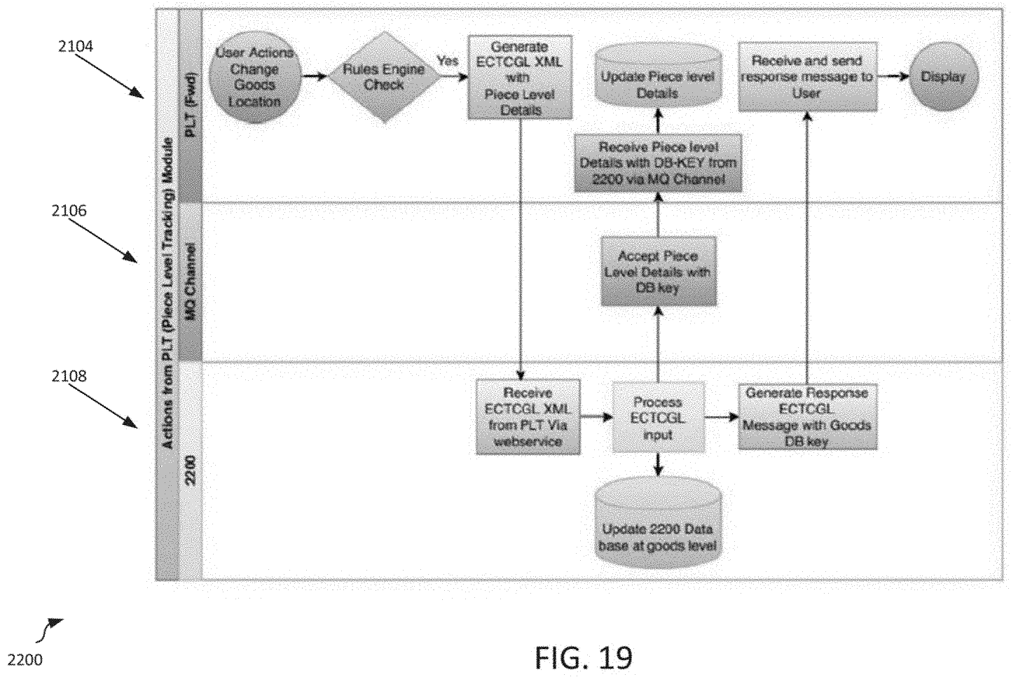

FIG. 19 is an example flowchart 2200 of an implementation of the piece level tracking service, in accordance with some embodiments of the present disclosure. The flowchart 2200 is another example of the flowchart 2100 without the scanner layer. The flowchart 2200 receives user actions, changes goods locations, inputs, and displays a message response to a user at the piece level tracking layer 2104. The goods level database, resident in the operating system layer 2108, and piece level database resident in the piece level tracking layer 2104, are updated following a similar process as illustrated and described in reference to FIG. 18, so discussion thereof is omitted here.

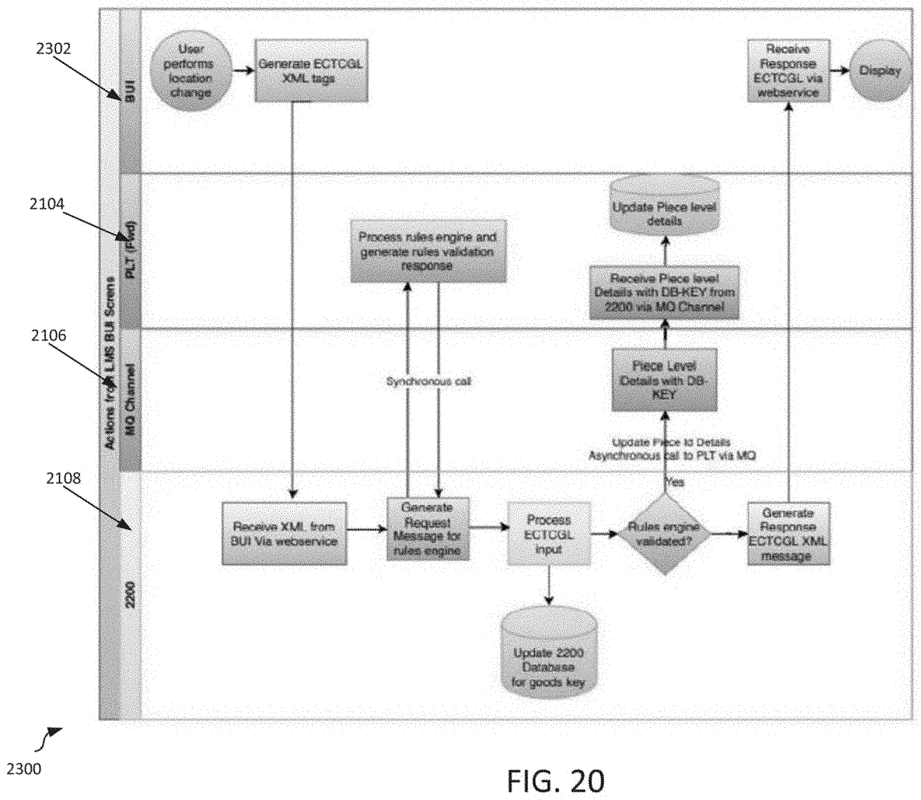

FIG. 20 is an example flowchart 2300 of a further example implementation of the piece level tracking service. This example includes a user-interface layer 2302. The user performs a piece level change at the user-interface layer these changes are passed off to the operating system layer 2108. The operating system generates a rules engine request which is processed at the piece level tracking layer 2104 with a synchronous call. After the rules engine check the goods level database and piece level database are updated in a similar process as illustrated and described in reference to FIG. 18. The user-interface layer 2302 then receives a message which it displays using the user interface.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

The above specification, examples and data provide a complete description of the manufacture and use of the composition of the invention. Since many embodiments of the invention can be made without departing from the spirit and scope of the invention, the invention resides in the claims hereinafter appended.

1. A freight tracking system comprising:
a freight logistics computing device comprising a processor executing instructions stored in memory, wherein the instructions cause the processor to:
receive an order for shipping goods in bulk at a goods level, wherein the order is associated with a plurality of pieces;
define a rules engine which is configured to enable or disable piece level tracking;
track at least one piece of the plurality of pieces at a piece level when piece level tracking is enabled; and
expose a record providing piece level information including when the at least one piece contains different information from at least one other piece of the plurality of pieces.

2. The system of claim 1, wherein the different information comprises a different attribute of the at least one piece.

3. The system of claim 2, wherein the attribute is a location of the at least one piece.

4. The system of claim 1, wherein the different information comprises a different routing information of the at least one piece.

5. The system of claim 1, wherein the instructions are further executable to enable or disable piece level tracking automatically.

6. The system of claim 5, wherein the instructions are further executable to disable piece level tracking for one or more pieces of the plurality of pieces when the one or more pieces are received at a location which does not support piece level tracking.

7. The system of claim 5, wherein the instructions are further executable to enable piece level tracking for one or more pieces of the plurality of pieces when the one or more pieces are received at a location which supports piece level tracking.

8. The system of claim 1, further comprising an input device to receive piece level information, wherein the input device is one of:
(1) a barcode scanner;
(2) a RFID scanner; and
(3) a global position system (GPS).

9. The system of claim 1, wherein the instructions are further executable to:
track at least two pieces of the plurality of pieces at a group level, wherein the group level defines routing information which is the same for the two or more pieces.

10. A freight tracking method comprising:
receiving an order for shipping goods in bulk at a goods level, wherein the order is associated with a plurality of pieces;
defining a rules engine which is configured to enable or disable piece level tracking;
tracking at least one piece of the plurality of pieces at a piece level when piece level tracking is enabled; and
exposing a record providing piece level information including when the at least one piece contains different information from at least one other piece of the plurality of pieces.

11. The method of claim 10, wherein the different information comprises a different attribute of at least one piece.

12. The method of claim 11, wherein the different information comprises a plurality of different attributes of the at least one piece, wherein one of the plurality of different attributes is a weight of the at least one piece.

13. They method of claim 10, wherein the different information comprises different dimensions of the at least one piece relative to other pieces included among the plurality of pieces in the order.

14. The method of claim 10, the method further comprising:
disabling piece level tracking for one or more pieces of the plurality of pieces when the one or more pieces are received at a location which does not support piece level tracking.

15. The method of claim 10, the method further comprising:
enabling piece level tracking for one or more pieces of the plurality of pieces when the one or more pieces are received at a location which supports piece level tracking.

16. The method of claim 10, the method further comprising:
verifying at least one piece of the plurality of pieces based on the record.

17. A freight tracking method comprising:
placing an order for shipping goods in bulk at a goods level, wherein the order is associated with a plurality of pieces;
selecting at least one piece of the plurality of pieces for piece level tracking, wherein selecting at least one piece for piece level tracking checks a rules engine to enable piece level tracking;
providing piece level information for the at least one piece; and
receiving a record providing piece level information including a unique piece identifier for the at least one piece.

18. The method of claim 17, wherein the record including the piece level information for the at least one piece contains different information from records associated with at least one other piece of the plurality of pieces.

19. The method of claim 18, further comprising:
updating the rules engine to disable piece level tracking.

20. The method of claim 17, further comprising, prior to selecting the at least one piece of the plurality of pieces for piece level tracking:
assessing whether piece level tracking is supported for an air waybill that includes the plurality of pieces; and
determining whether verification of a piece identifier for the at least one piece is required.

21. The method of claim 20, further comprising determining whether, at a particular location, a user is required to specify the piece identifier to perform an action regarding the at least one piece.
